(19) United States
(12) Patent Application Publication
(10) Pub. No.: US 2011/0088298 A1
(43) Pub. Date: Apr. 21, 2011

(54) Signage apparatus having simple magnet-based structure for ease of modification

(76) Inventor: Kirk Pemberton, Gardena, CA (US)

(21) Appl. No.: 12/928,716

(22) Filed: Dec. 17, 2010

Related U.S. Application Data
(63) Continuation-in-part of application No. 11/653,063, filed on Jan. 12, 2007, now Pat. No. 7,870,687.

(51) Int. Cl. G09F 13/04

(52) U.S. Cl. 40/541

(57) ABSTRACT

A readily modifiable modular sign apparatus is especially useful for fast food restaurants as backlighted menu boards in both indoor and outdoor applications. The apparatus comprises a preferably translucent substrate or mounting board which is preferably planar and has a front surface and a back surface. Precisely positioned holes are prepared at selected locations. These holes are formed to be aligned with thin metal shims which are affixed on the back surface of the mounting board and receive cylindrical magnets on the front surface. The magnets are attached directly to the rear of printed sheets, each of which may have wording or pictorial information or both. The magnets contact the metal shims through the mounting board holes, and are held firmly in position by virtue of both the magnetic attractive force and the shape of the walls of the mounting board holes. The printed sheets may be provided with price carriers to permit personnel to change just food prices without the requirement to replace the entire printed sheet. In the preferred embodiment of the present invention, a free-standing unitary LED backlighted sign, employs the magnet-based features hereof to secure an advertising display in a framed configuration wherein a magnet-secured frame adds to securely positioning a printed sheet.

### CROSS-REFERENCE TO RELATED APPLICATIONS

This application is a continuation-in-part of patent application Ser. No. 11/653,063 filed on Jan. 12, 2007.

### BACKGROUND OF THE INVENTION

1. Field of the Invention

The present invention relates generally to signs of the type used in fast food restaurants, coffee shops and other retail stores where items offered for sale and their prices frequently change. More specifically, the invention herein relates to a readily modifiable menu board or similar sign which employs a relatively simple magnet-based structure to facilitate easy modifications by non-technical personnel.

2. Background Art

Modular panel signs are most commonly found in fast food restaurants for display of their food menu in both outdoor and indoor applications. Such signs are usually backlighted and often contain verbal and graphical descriptions of food items and their respective retail prices. One of the key attributes of such menu signs is that they're usually the best and often the only source of menu information for the retail consumer in the restaurant or in the drive-through lane of the restaurant. Therefore, such signs are of critical importance to the successful operation of the restaurant. Their price information is very important as is their graphics which may both provide information about and entice the prospective fast food consumer to purchase a particular food item based on its visual appearance. A common characteristic of restaurants and other food-oriented retail establishments, particularly fast food stores, is that their menu changes often. Either the food items or the respective prices for food items or both, will change frequently to accommodate new offerings, delete less popular items and reflect virtually constantly revised prices to respond to competition or to comport with media advertising. For this reason, it is important that signs are relatively easy to update frequently and that signs can be modified by unsophisticated personnel without requiring elaborate and expensive training.

Issued U.S. Pat. Nos. 6,003,258 and 6,282,825 to Godfrey et al disclose one prior art sign assembly which addresses the need for a menu board type display which can be modified to other content including price information. The sign assembly of the Godfrey et al patents comprises a frame design having distinct front and rear portions as shown, for example, in their FIG. 6. The rear portion comprises a frame and the front portion comprises a mechanically mating transparent cover panel which holds a plastic sheet and a sign element which has graphics printed thereon. The cover panel uses magnetic strips to adhere to the frame at mating metallic strips which are adhesively secured to the frame at matching locations. Separate retention members and stop elements are employed to prevent the sign from sliding out of position. The sign element may be in the form of elongated strips as shown in their FIG. 21. Each such strip is disclosed as having a front piece and a back piece. The front piece has a number of rectangular windows and the back piece has a corresponding number of aligned price pockets for holding inserted numerical indicia for displaying price information through the windows of the front piece. The front piece also has alphanumeric characters which may be printed thereon.

Another readily modified sign assembly for similar applications is disclosed in U.S. Pat. No. 6,182,387 to Duguay. This patent discloses a sign assembly having a magnetically attractable uniform surface completely covered by individual magnetic strips and price elements. Each such strip or element comprises a solid front surface bearing printed indicia and a magnet or magnetic strip affixed to the rear of the front surface. The magnet covers only a portion of the rear of the front surface so that a fulcrum point is formed to permit removal and replacement of the element or strip without special tools. A problem with such a sign assembly is that such a large plurality of separate sign elements do not provide a uniform and professional-looking appearance. Additionally, even with relatively strong magnets, the individual elements would tend to slide off of their intended positions.

Although the prior art disclosures address the need for a sign assembly that can be modified to accommodate frequent changes in food items and their respective prices, there are a number of disadvantages which remain. For example, the number of steps required to change a display are still greater than is desired. The structural complexity of the assembly is still higher than is preferred. The use of a frame of a particular size would make it disadvantageous to change the dimensions of the preferred sign graphics. The use of price pockets on a back piece that need to extend through aligned windows on a front piece, put undesirable constraints on the dimensions and manufacture of the signs and make the price pocket concept unnecessarily complex. The need for locking or stop elements to prevent sliding movement of the printed sign element within the assembled frame is also a disadvantage because it adds to the parts count and cost of the assembly. Moreover, a sign having a large number of individual magnetic pieces does not present a professional finished appearance.

Therefore, there is still an unresolved need for a readily modified signage apparatus which overcomes the noted deficiencies of the prior art. More specifically, it would be highly advantageous if there were a sign assembly which did not require a frame structure, which did not need separate locking or stop elements, which did not utilize separate front and back pieces for price pockets, which was of even simpler structure, which required even fewer steps to change sign content and which still provided a neat, finished and professional looking appearance.

### SUMMARY OF THE INVENTION

The present invention, in its preferred embodiment, provides a simple and advantageous solution for the previously unresolved need for a readily modifiable modular sign apparatus that is especially useful for fast food restaurants as backlighted menu boards in both indoor and outdoor applications. The apparatus comprises a preferably translucent substrate or mounting board which may be made of an acrylic or other rigid material including, for example, polycarbonate or styrene. The mounting board is preferably planar and has a front surface and a back surface and in a preferred embodiment is about 5 mm in thickness. Precisely positioned holes are prepared at selected locations. These holes are formed to be aligned with thin metal shims which are affixed on the back surface of the mounting board and receive cylindrical magnets on the front surface. The magnets are attached directly to the rear of printed sheets, each of which may have wording or pictorial information or both. The magnets contact the metal shims through the mounting board holes, and are held firmly in position by virtue of both the magnetic attractive force and the shape of the walls of the mounting board holes. The mounting board holes are preferably beveled toward the front surface of the board to make it easier to locate the magnets accurately and to remove them when it is desired to replace the printed sheet.

The printed sheets have precise, selected dimensions to fill a desired space on the substrate or mounting board, while at the same time, having one or more edges which closely align with one or more corresponding edges or borders of the mounting board. For example, where a printed sheet is rectangular in shape, its upper edge may be substantially congruent to the upper edge of the mounting board. This alignment precision is dependent on the location of the holes and metal shims on the mounting board and on the accuracy of placement of the magnets that are affixed on the back surface of the printed sheets.

Changing the content of a sign of the present invention, involves the simple steps of removing a sheet by pulling the sheet and its adhered magnets away the mounting board and replacing it with another printed sheet having magnets which mate with the mounting board holes. Border or edge members made of plastic or other inexpensive materials, may be preferably used between adjacent printed sheets to provide a neat finished appearance. Such border members may be secured to the mounting board using holes and metal shims and adhered magnets in the same manner as the printed sheets are secured.

The printed sheets may be provided with price carriers to permit personnel to change just food prices without the requirement to replace the entire printed sheet. In the preferred embodiment of the present invention, such price carriers are affixed directly to the front surface of the printed sheets in a unitary, integrated structure that provides easy access to the price indicia.

The mounting board may be provided with a large number of extra holes with affixed metal shims so that the size and shape of the printed sheets may be altered as well, by simply adjusting the locations of the affixed magnets on the replacement sheets. This feature provides the added flexibility of changing the module geometry of a modular sign assembly without replacing the mounting board.

In yet another preferred embodiment of the present invention, a free-standing or wall mountable backlighted graphics display, preferably holding a unitary printed sheet, is provided. This embodiment employs the magnet-based features of the menu board, but in a framed configuration wherein a magnet-secured frame adds to securely positioning a translucent printed sheet such as for advertising or informational purposes. LED backlighting may be preferably employed to make the display thin and lightweight. Changing the printed sheet is extremely simple and fast.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional view of a fast food outdoor modular, backlighted sign display in which an embodiment of the invention is employed;

FIG. 2 is a partially exploded view of the sign display of FIG. 1;

FIG. 3 is a further enlarged and exploded view of a selected module of the sign display of FIG. 1;

FIG. 4, comprising FIGS. 4A, 4B and 4C, is a still further enlarged view of a portion of a selected module of the sign display of FIG. 3;

FIG. 5, comprising FIGS. 5A, 5B and 5C, is a view of an edge member used in the embodiment of FIG. 1;

FIG. 6, comprising FIGS. 6A, 6B and 6C, is a view of a price carrier construction of the embodiment of FIG. 1;

FIG. 7 is an exploded view of the price carrier of FIG. 6;

FIG. 8 is a plan view of a mounting board assembly of the sign display of FIG. 1;

FIG. 9 is a three-dimensional view of a preferred embodiment of a backlighted sign hereof;

FIG. 10 is an edge view of the sign of FIG. 9;

FIG. 11 is an exploded view of the sign of FIG. 9;

FIG. 12 is an enlarged partial view of a corner of the sign of FIG. 9 with frame removed;

FIG. 13 is a cross-sectional view taken along lines 13-13 of FIG. 12;

FIG. 14 is a cross-sectional view taken along the same lines of FIG. 13, but showing a graphics sheet installed;

FIG. 15 is a cross-sectional view taken along lines 15-15 of FIG. 12;

FIG. 16 is a view similar to that of FIG. 15, but showing a frame installed; and

FIG. 17 is an enlarged partial view of a corner of the frame of FIG. 9, similar to that of FIG. 12, but with the frame installed.

### DETAILED DESCRIPTION OF A PREFERRED EMBODIMENT

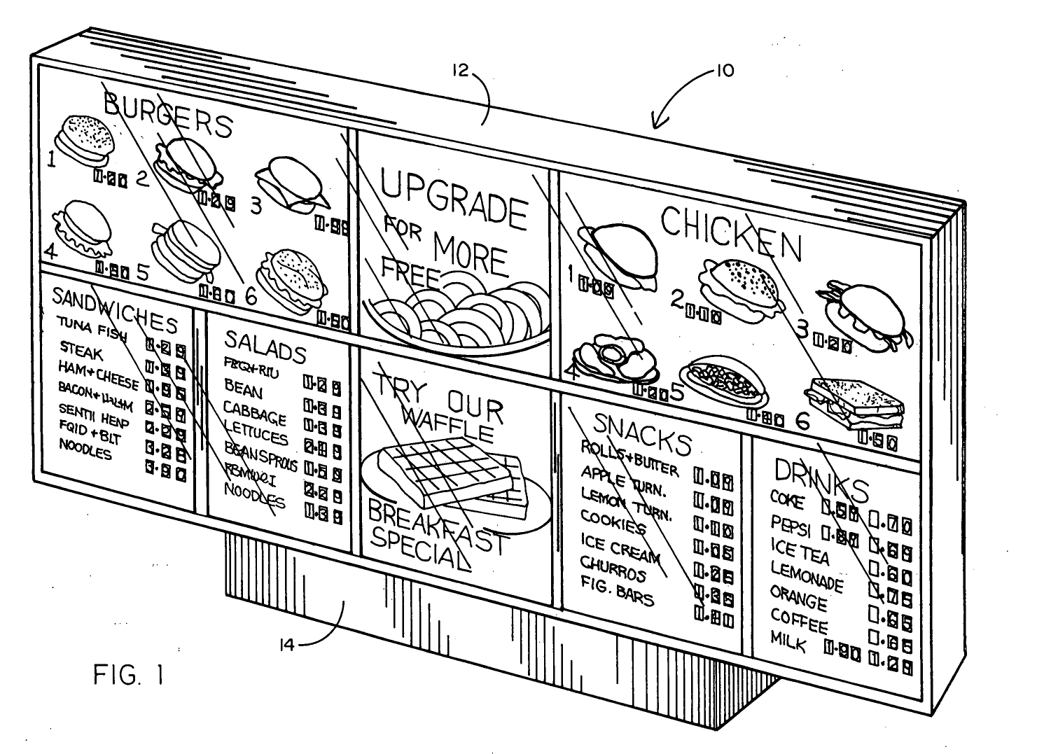

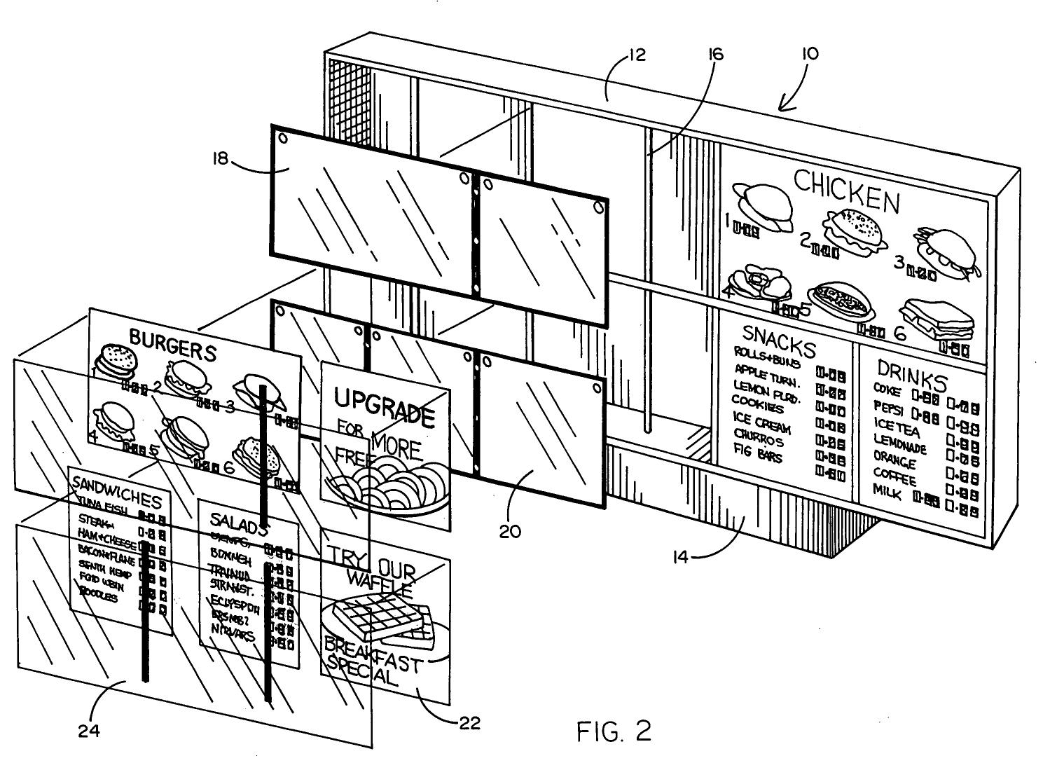

Referring to the accompanying drawings and initially to FIGS. 1-3, it will be seen that a modular display 10 comprises a rectangular enclosure 12 resting on a base 14. The enclosure 12 has a plurality of backlights 16 in the form of vertical fluorescent tubes. A plurality of rectangular mounting boards 18, 19, 20 and 21 are positioned in front of the backlights 16. Each such mounting board is covered by one or more printed sheets 22. A transparent hard plastic protective cover 24 overlies the printed sheets. Between each pair of adjacent printed sheets 22 is an edge member 27.

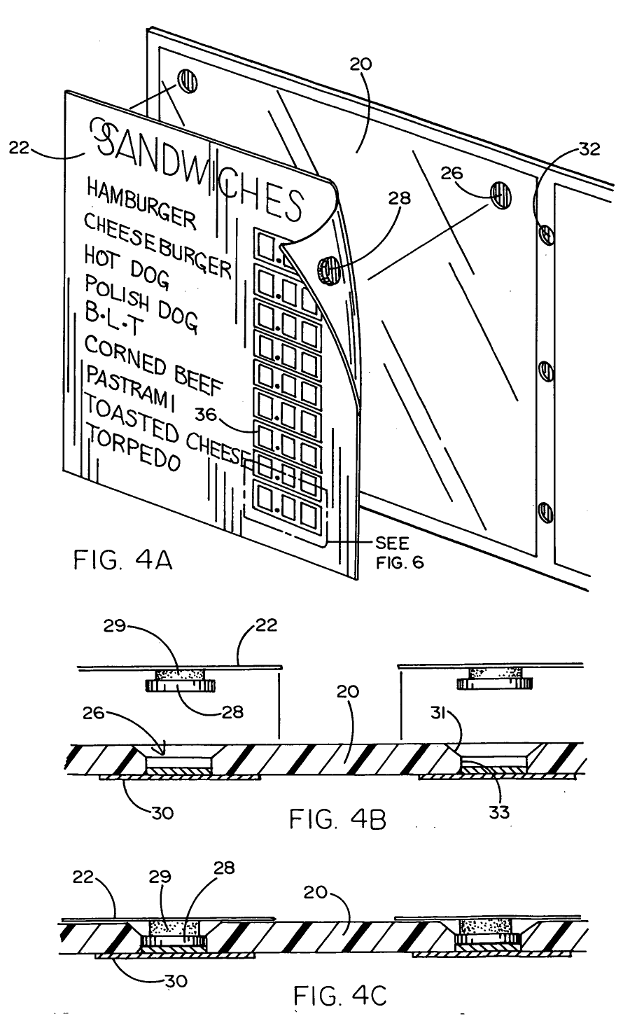

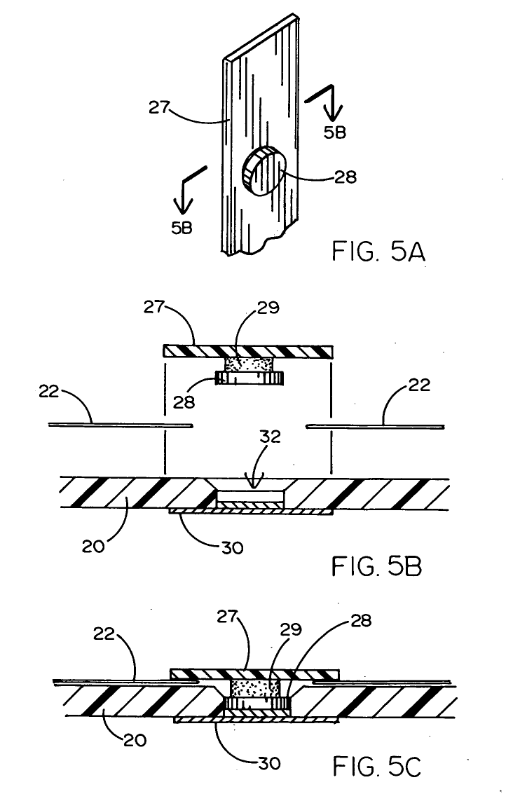

The manner in which the printed sheets and edge members are secured to the mounting board is shown in FIGS. 4 and 5. Referring first to FIG. 4, it will be seen that each printed sheet 22 is attached to the mounting board at a pair of apertures 26 using a corresponding pair of flat cylindrical magnets 28. Each such magnet is adhesively affixed to a sponge-like material 29 which is, in turn, glued to the back of the printed sheet 22 at precisely selected locations. As shown best in FIGS. 4B and 4C, the back surface of the mounting board has a round metal shim 30 aligned with each aperture 26 and adhered to the mounting board surface. Each such aperture 26 has a beveled front portion 31 and straight-walled portion 33. The magnets 28, each extend through the beveled portion 31 and rest in the straight-walled portion 33 where it contacts the metal shim 30.

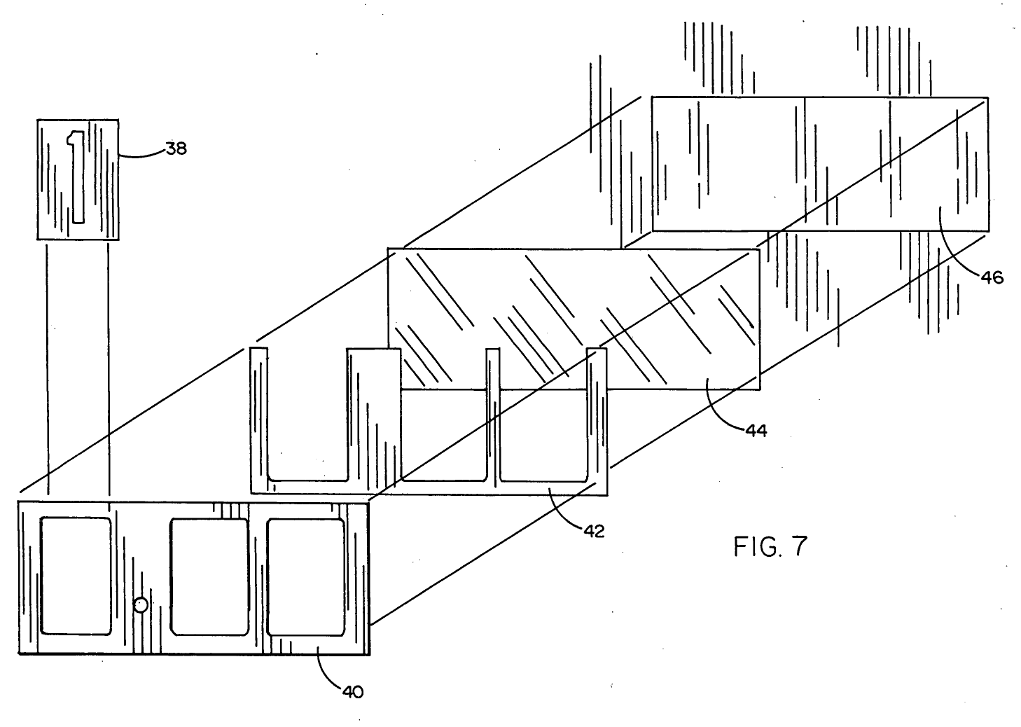

As shown in FIGS. 5A, 5B and 5C, each edge member 27 is connected using a plurality of the magnets 28 in mounting board apertures 32. Each such aperture 32 has the same structure (i.e. partially beveled, partially straight) as the aperture 26 and also terminates in a round metal shim 30. The edge members 27 preferably overlap the adjacent edges of two sheets 22 to provide a finished, neat look to the display. The relative positions of the mounting boards 18, 19, 20 and 21 and their respective apertures 26 and 32 are shown in FIG. 8 for the entire modular display 10.

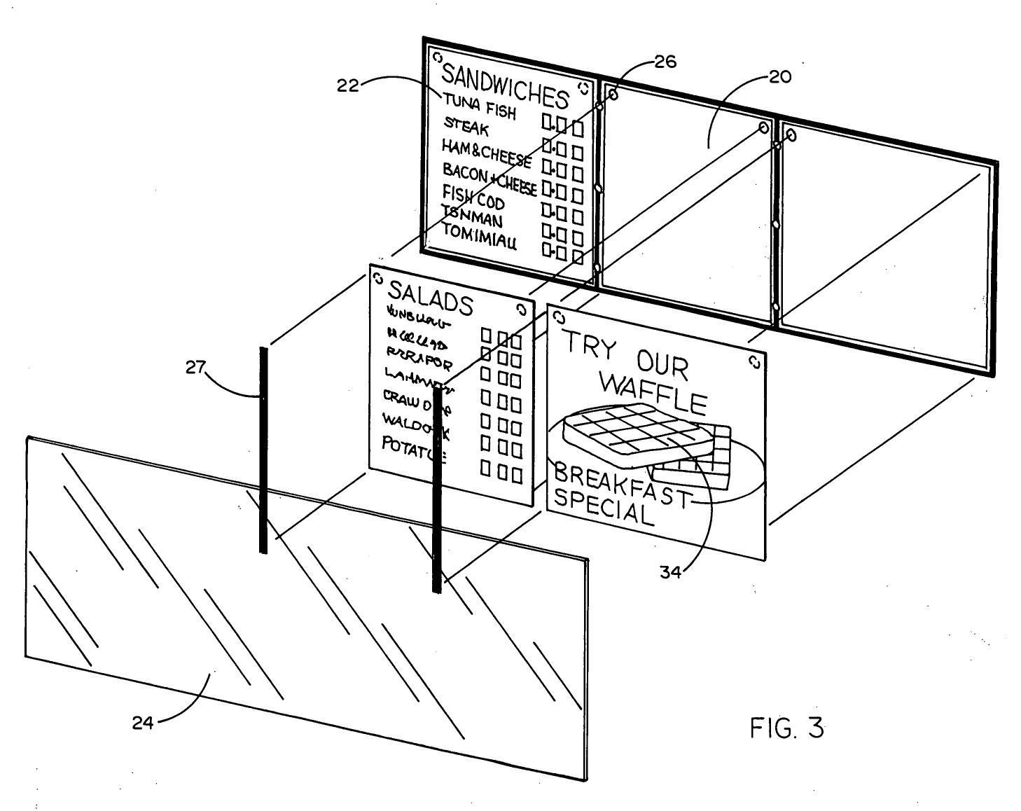

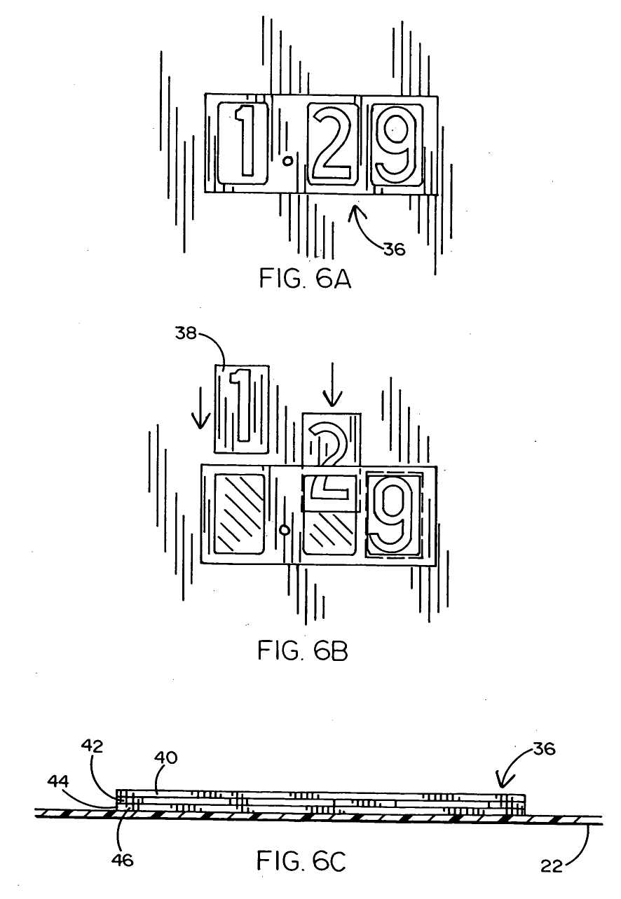

As seen in FIGS. 3 and 4A, some of the printed sheets 22 may have graphics 34 and/or wording 35 as well as price carriers 36. Price carriers permit price changes to be made without replacing the sheets. Their structure is shown in FIGS. 6A, 6B, 6C and 7. As shown in those figures, a price carrier 36 according to a preferred embodiment of the present invention, comprises at least one number sheet 38, a window member 40, a number sheet holder 42, a slip member 44 and a backing 46. These constituent parts are adhesively assembled as shown in FIG. 7 and then secured to the front surface of a printed sheet 22 as shown in FIG. 6C. The number sheets 38, reflecting the current price of a product, are then inserted as shown in FIG. 6B to provide a selected price as shown in FIG. 6A.

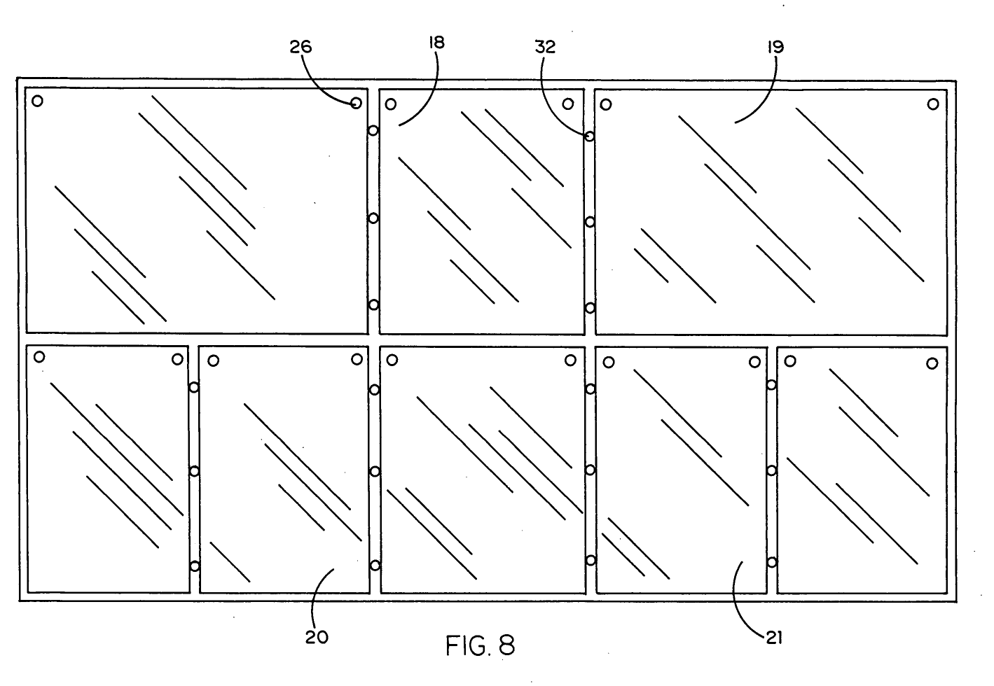

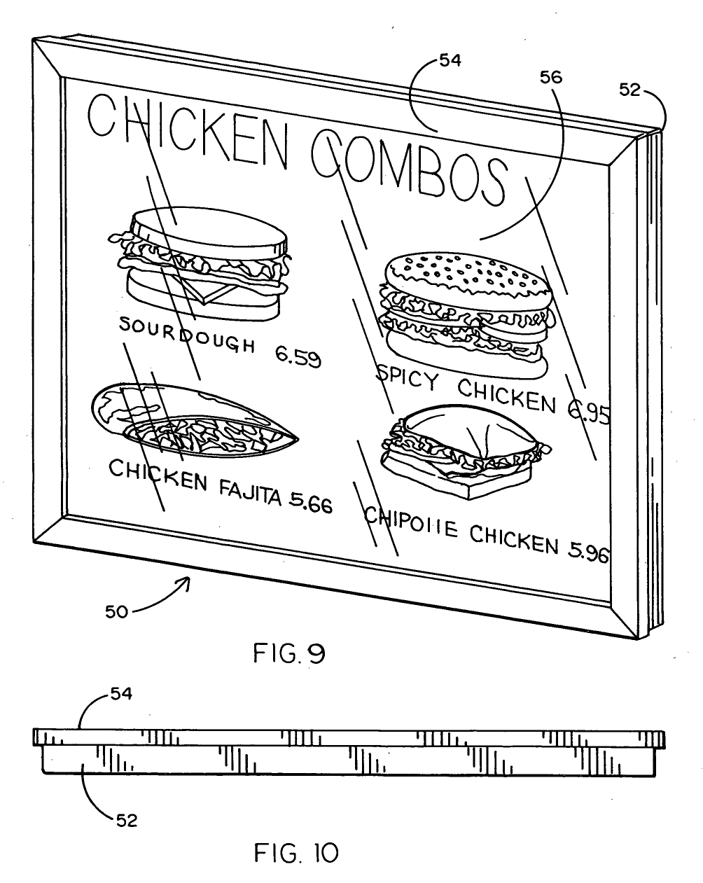

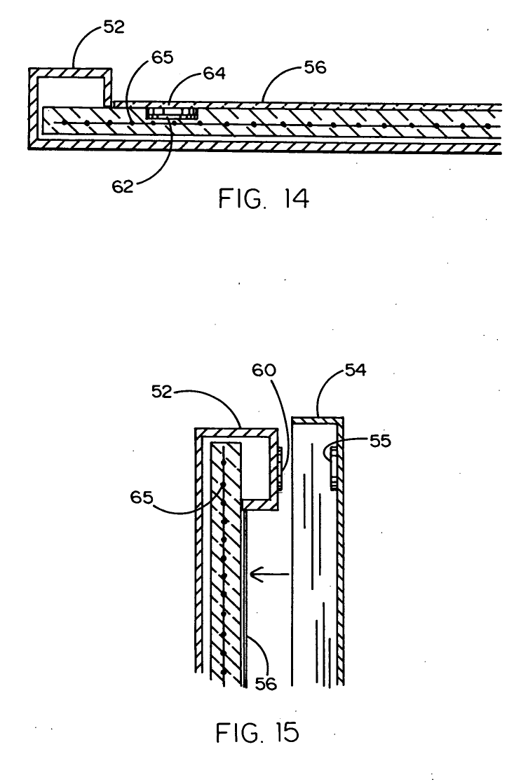

Referring now to FIGS. 9-17, it will be seen that the present invention also provides other sign configurations. More specifically, as shown in FIGS. 9-17, the present invention relates also to a unitary backlighted sign display 50 which has a base section 52 and an outer frame 54 for supporting a graphics sheet 56 as seen best in FIGS. 9-11. Base section 52 comprises a hard translucent surface 58 behind which there is an array of LEDs 65 for generating a bright, lighted environment to improve viewing of the graphics sheet 56.

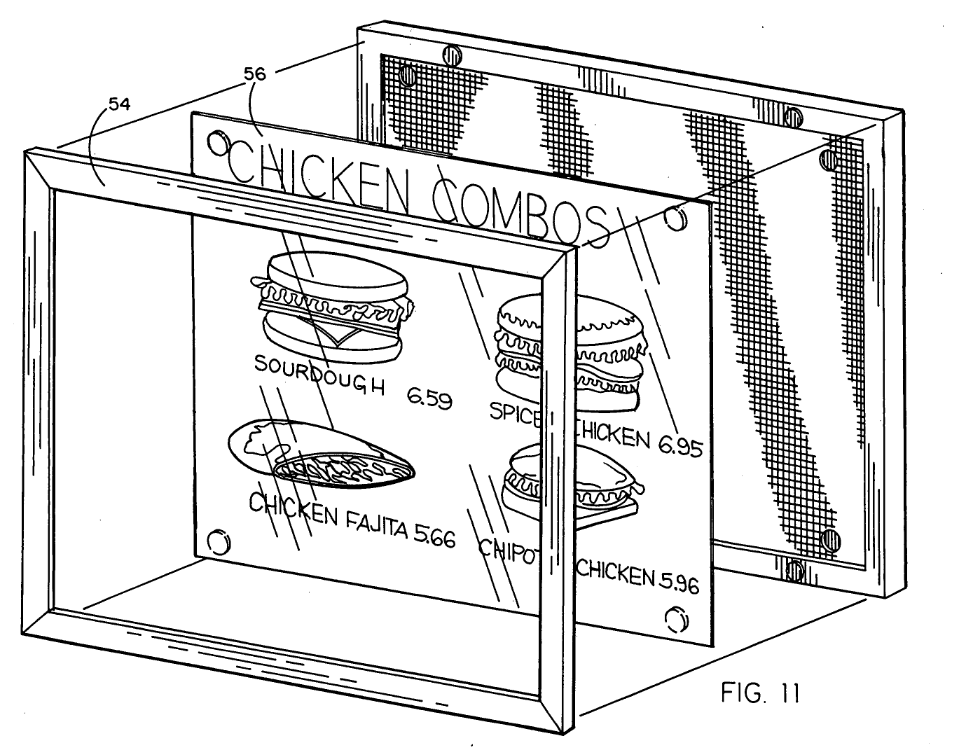

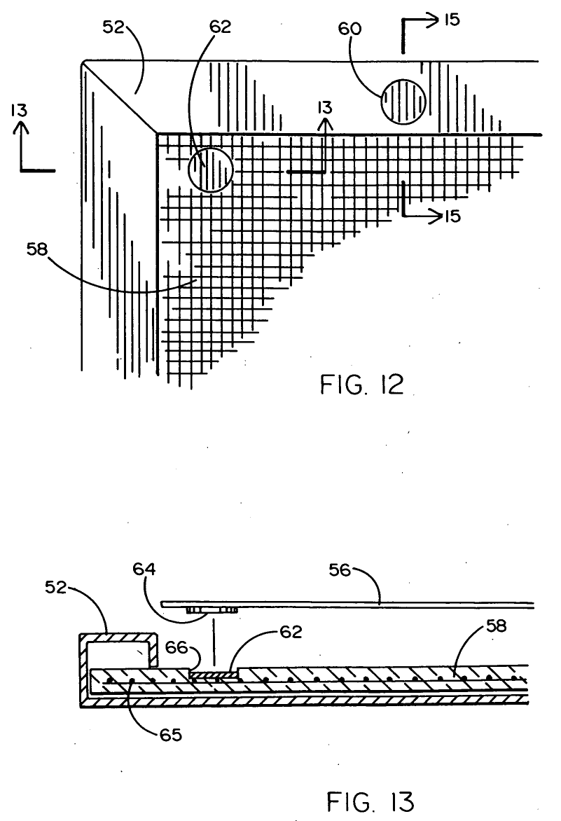

The more significant aspects of the embodiment of FIGS. 9-17 are the ways in which the assembly employs magnets to both secure the graphics sheet 56 to the translucent board 58 and to secure frame 54 to the base section 52. These aspects of the invention are best understood by referring to FIGS. 12-17.

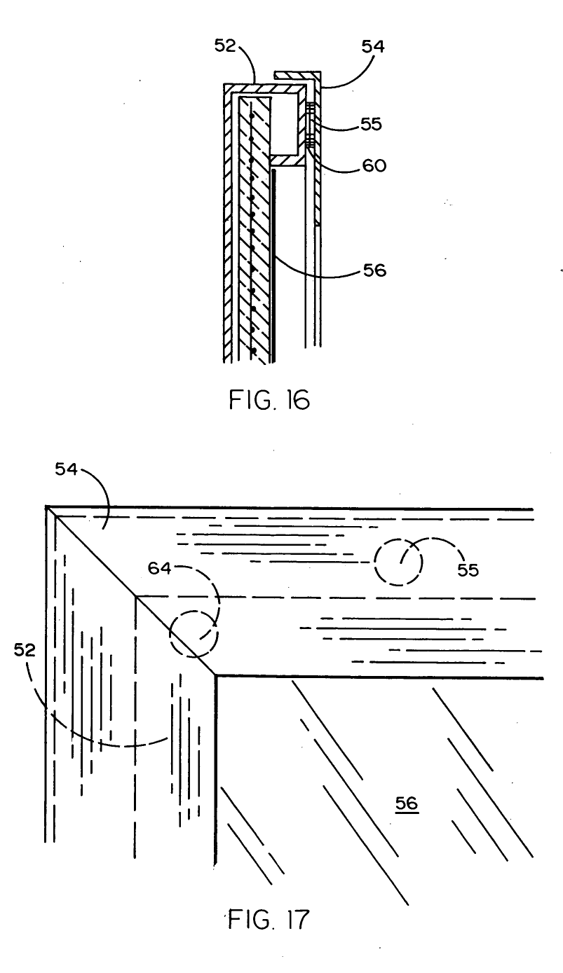

As shown in FIGS. 12-17, a magnet 62 is secured such as by adhesive in an aperture 66 of the board 58. It would be preferable to have at least two such sets of magnets in apertures at the upper corners of the board 58 and most preferable to provide one at each of the four corners thereof. The graphics sheet 56 has a metal member 64 on the inner surface of the sheet at corresponding locations to secure the graphics sheet 56 to the board 58 in the manger taught herein. Similarly, the frame 54 employs a plurality of magnets 55 on the inner surface of the frame (see FIGS. 15 and 16) to mate with a plurality of corresponding metal members 60 on the base section 52 to secure the frame in a similar manner. An advantage of this configuration is that the frame overlays the edge of the graphics sheet thereby hiding the magnets and metal members used to secure the sheet and thereby preserving the aesthetic appearance of the sign display 50.

Having thus disclosed a preferred embodiment of the invention, it will now be understood that various modifications may be made while still utilizing the novel features thereof. By way of example, the precise size, position and shape of printed sheets may be modified. Moreover, the location, shape and number of magnets used to secure the printed sheets to a mounting board may be modified. Furthermore, in some cases the disclosed magnets and mating metal members or shims may be interchanged while still achieving the purposes and advantages thereof. Therefore, it will be understood that the scope hereof is not limited by the disclosed preferred embodiment, but only by the appended claims and their equivalents.

We claim:

1. A backlighted sign comprising:
a base having a translucent surface for receiving a graphics sheet and a source of illumination for generating a lighted background behind said surface and skid sheet.
A graphics sheet secured to said translucent surface by at least one magnet; and
A frame secured to said base along the perimeter of said graphics sheet and affixed to said base by at least one magnet.

2. The backlighted sign recited in claim 1 wherein said source of illumination comprises an array of LED lights.

3. The backlighted sign recited in claim 1 wherein said graphics sheet is secured to said translucent surface by at least two magnets at respective upper corners of said graphics sheet.

4. The backlighted sign recited in claim 1 wherein said frame is secured to base by a plurality of magnets at respective corners of said frame.

5. The backlighted sign recited in claim 1 wherein said graphics sheet is secured to said translucent surface by at least one magnet affixed to said base and at least one metal member affixed to said graphics sheet.

6. The backlighted sign recited in claim 1 wherein said frame is secured to said base by at least one magnet affixed said frame and at least one metal member affixed to said base.
